(19) United States
(12) Patent Application Publication
(10) Pub. No.: US 2009/0064246 A1
(43) Pub. Date: Mar. 5, 2009

(54) DISTRIBUTED AND INTERACTIVE GLOBECASTING SYSTEM

(76) Inventor: Gregory P. Bell, Dallas, TX (US)

Correspondence Address: GREENBERG TRAURIG, 3773 HOWARD HUGHES PARKWAY, SUITE 500 NORTH, LAS VEGAS, NV, 89169, US

(21) Appl. No.: 11/848,079

(22) Filed: Aug. 30, 2007

(51) Int. Cl. H04N 7/173

(52) U.S. Cl. 725/105; 725/109; 725/87

(57) ABSTRACT

Described is a distributed, interactive broadcast system having a plurality of robotic modules coupled to a broadcast control center and data center, the control center and data center capable of pulling and pushing audio and visual information from and to each individual robotic module within the distributed, interactive broadcast system. The system being ideal for broadcasting live events from venues equipped with audio and video devices. Interactive applications are also facilitated by the system allowing for real-time interactivity between global remote viewers and with spectators at the venue.

### FIELD OF THE INVENTION

The embodiments of the present invention relate to broadcast systems, more specifically, to a system and method of broadcasting live events to remote viewers.

### BACKGROUND

The broadcast of pre-recorded and live events is well-known. Most of these events are audio broadcasts or a combination of video and audio broadcasts utilizing radio, television, cable and/or satellite. There are limitations to these broadcast techniques. For example, radio broadcasts provide no visual representation of the action being described. Video broadcasts are restricted by availability of television, cable and/or satellite providers and signals. In some instances, the providers may not carry all events of interest.

Thus, there exists a need for an interactive remote controlled environment capable of providing real-time electronic audio and video transmissions to remote viewers.

### SUMMARY

Accordingly, a first embodiment of the present invention discloses a robotic system for broadcasting an event from a venue comprising: broadcast equipment disposed about the venue, said broadcast equipment operable to capture audio and video data relative to a live event; at least one robotic module in communication with the broadcast equipment, the robotic module configured to receive said audio and video data from the broadcast equipment; a control center wherein said control center is configured to pull audio and video data from the robotic module; and means for transmitting said audio and video data to remote locations.

Another embodiment discloses an integrated broadcast system comprising: a plurality of robotic modules; and a control center coupled to the plurality of robotic modules, the control center configured to pull audio and video data from the plurality of robotic modules. The control center is further configured to push audio and video data to the plurality of robotic modules. In one embodiment, a venue is associated with each robotic module. The control center can be further configured to pull a first audio and video data from a first robotic module at a first venue and push the first audio and video data to a second robotic module at a second venue. A plurality of visual displays and burners can be configured to receive audio and video data from the associated robotic module. The robotic module can also be configured to send audio and video data to the plurality of visual displays disposed about the associated venue.

A method of providing audio and video content from a venue comprises: utilizing broadcast equipment disposed about the venue to capture audio and video data relative to a live event; configuring at least one robotic module in communication with the broadcast equipment to receive said audio and video data from the broadcast equipment; configuring a control center to pull audio and video data from the robotic module; and transmitting said audio and video data to remote locations.

Other variations, embodiments and features of the present invention will become evident from the following detailed description, drawings and claims.

### BRIEF DESCRIPTION OF THE DRAWINGS

FIG. 1 is a block diagram illustrating an integrated broadcast system;

FIG. 2 is a block diagram illustrating a distributed robotic system;

FIG. 3 is a block diagram illustrating a method of placing an order through the integrated broadcast system; and

FIGS. 4A-4B are exemplary web pages of a web-based system for allowing customers to order live events pursuant to the embodiments of the present invention.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

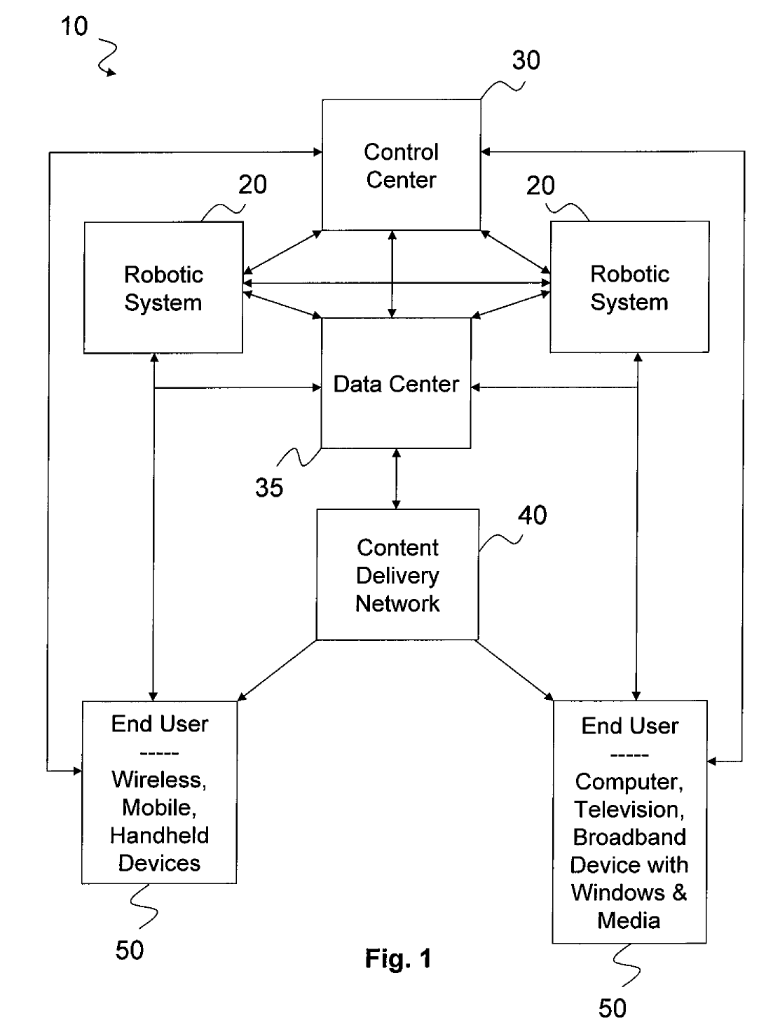

FIG. 1 is a block diagram illustrating an integrated broadcast system 10 according to the presently disclosed invention. The broadcast system 10 includes a plurality of robotic systems 20, each being deployed at various venues and outlets. Each robotic system 20 is capable of bidirectional communication with a control center 30, a data center 35 and with other robotic systems 20 distributed throughout the broadcast system 10. The bi-directional communication network also allows multiple robotic systems 20 at a single venue to communicate with one another, robotic systems 20 at other venues and the control center 30 and data center 35. Although each robotic system 20 can be controlled and operated locally at the venue or event, the bidirectional communication network also allows remote control and operation of each system 20 by the control center 30. In other instances, the robotic systems 20, control center 30 and data center 35 can be controlled and operated by a third party in communication with the network.

The bi-directional communication network within the broadcast system 10 includes satellite uplink and pull-down capabilities. Information including audio/video and data transmissions can be pulled from or pushed to each robotic system 20 via the control center 30 or data center 35. The push/pull bi-directional communication can also take place between robotic systems 20 such that audio/video and data transmissions can be pulled from or pushed to a first robotic system 20 via a second robotic system 20, and vice versa. In other instances, the communication need not take place via satellite but can use broadband, high-speed Internet, telephone lines, fiber optic circuits and other suitable communication and network systems and methods. Additionally, streaming of audio/video and other live events can be pushed to or pulled from the robotic system 20, control center 30 or data center 35. The details of a robotic system 20 and its relationship and interaction with other robotic systems 20 and with the control center 30 and data center 35 will be discussed further below.

The integrated broadcast system 10 also includes a content delivery network 40 having a globally distributed network of thousands of servers configured to deliver media content including audio/video media of live events as captured by each robotic system 20. The content delivery network 40 can also deliver media content from the control center 30 or data center 35. Whether pre-recorded or captured live, the media content can be uploaded to servers residing on the content delivery network 40. The media content can also be uploaded or pushed to the control center 30, data center 35 or stored on other suitable servers and databases within the broadcast system 10. Although described as audio/video media of live events, the media content may also be pre-recorded news or entertainment programs. The media content can also be digital media including the likes of videos, movies, music, games, software and social media, as well as media from public broadcast affiliates, live webcasts, concerts and events, podcasts and any other sources of audio or video content. Further, the media content can come from storage devices such as CDs and DVDs or from a media library, which is a collection of media content stored on databases and servers within the content delivery network 40. The media library can be programmed to provide digital distribution of audio/video media content of live events or pre-recorded programming stored on DVDs. Alternatively, the media content can be stored on other suitable databases and servers within the integrated broadcast system 10.

When an end user 50 places a request for a media content like a sporting event or live concert from a particular venue, the content delivery network 40 distributes such media content to one or more intermediary storage server clusters (not shown), which subsequently feed hundreds of specially configured servers at multiple content delivery locations around the world. The media content can then be delivered directly to the end user 50 through broadband Internet service providers (ISPs) or over the public Internet system as appropriate in other instances, the content delivery network 40 can be provided by a third party such as Limelight Networks®.

The end user 50 can receive the media content or programming via any broadband enabled consumer displays including computer (PCs and Macs), television (including HDTV), TiVo, digital video recorder, iPod, Sony PlayStation Portable (PSP) and Apple TV. Furthermore, the end user 50 can also receive the on-demand streaming media using wireless, mobile or handheld devices such as mobile phones, PDAs, Blackberries, iPods or iPhones equipped with Windows and Media Player. The media content may also be provided in Adobe Flash, MP3 audio, QuickTime, Real Networks RealPlayer or other suitable format. In many instances, users 50 will access the live sporting events using a television or via the computer. In other instances, the media content may be broadcast at public venues such as bars, clubs, pubs or work places. Based on the embodiments of the present invention, end users 50 can access the programming from anywhere in the world using any suitable media delivery platform.

The media programming can be viewed live or as video-on-demand on either wired or wireless devices. The programming can also be pay-per-view or subscription based, and can include a mobile subscription service in which audio and video clips may be downloaded or streamed onto the mobile or handheld devices previously described. The media content can also include broadcasting of live sporting events over broadband to the television or computer of the end user 50. Live tournaments and special events including auctions, games and competitions can also take place wherein end users 50 utilize wireless devices such as cell phones or Blackberries to participate. These interactive participation activities can take place at a specific venue or globally via the Internet.

With a venue event, surveys, questions and items for bidding are provided in real-time on a Jumbotron or other types of visual displays that are generally available at the venue. End users 50 can participate by answering questions with wireless devices like cell phones or with their home computers. During live events end users 50 can engage in live, interactive bidding with their cell phones or Blackberries. Real-time cumulative results are subsequently projected on a Jumbotron or visual display at the venue. With a global event via the Internet, surveys, questions and items for bidding can be hosted on a central server and displayed on the end user's 50 television, computer or handheld wireless device. Accordingly, the user 50 can participate by providing responses using similar wired or wireless devices described above. Real-time cumulative results are accordingly projected on user cell phones or computer screens. Although surveys, questions and items for bidding are disclosed, end users 50 can also partake in events including interactive voting and advertising. Various audio/video clips and other special events can also be provided to end users 50.

While various services and media contents are described above, an end user 50 can choose from more than one of these various services and media contents described above utilizing different devices for different content types. In other words, the integrated broadcast system 10 is capable of providing multiple events from multiple locations as captured by multiple robotic systems 20, and controlling and distributing the media content to a global audience 50 via control center 30, data center 35 and content delivery network 40.

The broadcast system 10 further includes an operating system, which enables communication between each component within the robotic system 20 and the control center 30. The operating system can reside in each robotic system 20, control center 30, data center 35 or other suitable databases or servers within the broadcast system 10. The operating system allows the control center 30 or data center 35 to remotely control the functions and interactions between each robotic system 20, control center 30 and data center 35. The operating system further enables communication, and audio/video and data exchange between two or more robotic systems 20 within the broadcast system 10, whereby the communication and control may also be monitored by the control center 30 and data center 35. It will be appreciated by one skilled in the art that the broadcast system 10 can incorporate additional electronic components including switches, digital video effects and video overlays, as well as other suitable devices and components necessary to carry out the audio/video broadcast as described. Further, although shown separate, the control center 30 and data center 35 can be integrated as a single unit.

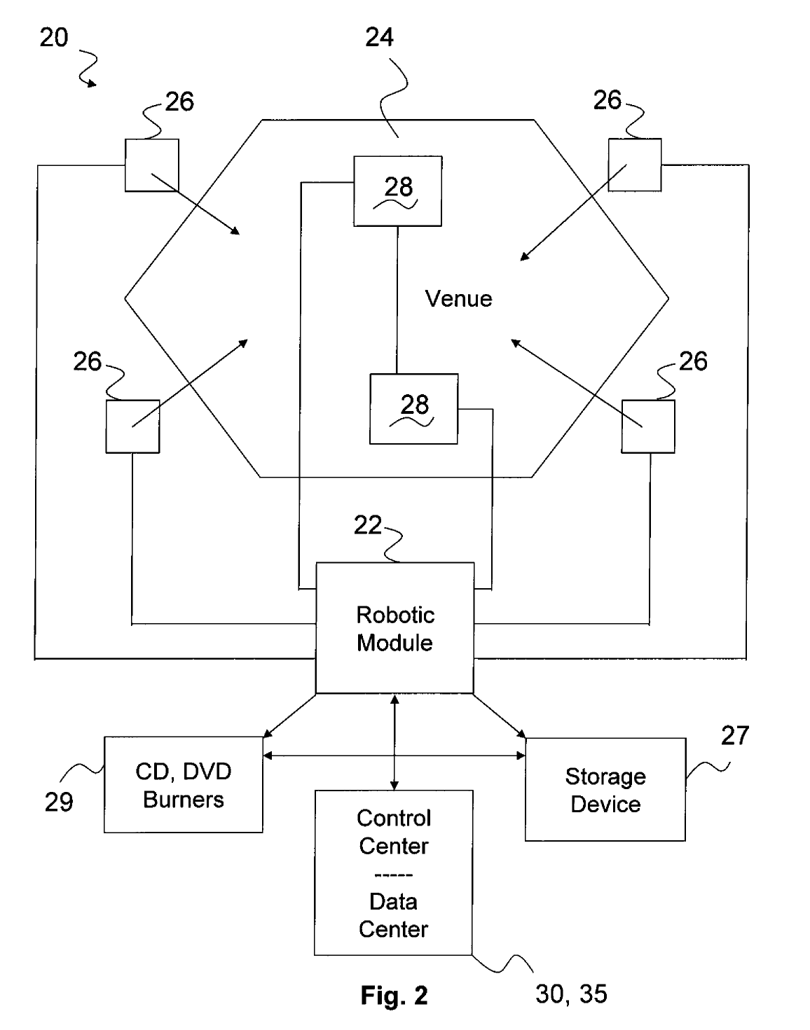

FIG. 2 is a block diagram illustrating the robotic system 20 previously disclosed. As shown in the figure, a robotic module 22 can be installed, temporarily or permanently, at a venue 24 including the likes of sports arenas, nightclubs, concert halls, schools and other outlets or facilities having special events. In one embodiment, there is pre-existing broadcast equipment including microphones and cameras 26 deployed throughout the venue 24. This is especially true of sporting stadiums and arenas commonly known for hosting professional or college football, basketball, baseball, hockey and soccer games. The venues 24 may also have Jumbotrons, large screen televisions and various types of signages and displays 28. Venues 24 lacking pre-installed or pre-existing broadcast equipment 26 or displays 28 as described above may be retrofitted with similar audio/visual devices 26, 28 at a later time. In some instances, the broadcast equipment 26 or display 28 can be provided by a mobile broadcasting truck.

The robotic module 22 includes a software application for the production and management of matrix-style switching of audio/video input and output feeds, the input preferably being provided by the microphones, cameras and other broadcast equipment 26 deployed throughout the venue 24. In one embodiment, the broadcast equipment 26 captures the event taking place within the venue 24 and feeds the captured signals to the robotic module 22 using BNC connectors, cable connectors, audio adaptors, video adaptors and other suitable encoders, connectors and adaptors. Alternatively, the input can also come from other types of audio/video devices. In one embodiment, the robotic module 22 includes four wired or wireless ports for audio/video selection and four input/output channels, and is capable of switching back and forth between four different cameras 26. It will be appreciated by one skilled in the art that there can be fewer or more ports and channels as needed. In other words, a venue 24 can have multiple microphones, cameras and broadcast equipment 26 and multiple robotic modules 22.

The robotic module 22 also includes a plurality of electronic input and output switches, receivers, encoders and other hardware devices and components to compliment the software application. Production control of media content utilizes a matrix-style switching that provides broadcasting in four channels. In other words, if there are four cameras 26 with corresponding microphones distributed throughout the stadium 24 at various locations, the robotic module 22 is capable of switching back and forth among the four different cameras 26 to provide different viewing angles of the event taking place within the venue 24. Like above, there can be fewer or more channels as needed. Encoders and switches assist in the production control process by facilitating the switching between cameras and other broadcast equipment 26 throughout the venue 24. In other instances, the switching can also be controlled by the control center 30 or data center 35 through the robotic module 22.

In other embodiments, the robotic module 22 can receive inputs from other audio/video switches and feeds that may be available at the venue 24 including audio/video inputs from broadcast trucks. The robotic module 22 can also receive audio/video inputs from CDs, DVDs or other storage devices. In other instances, the robotic module 22 can receive inputs from a text messaging data center, title generators or graphics generators that may be present at the venue 24. Using the bidirectional input/output capability of the robotic module 22, any audio/video inputs may be outputted to various devices including the Jumbotron or other types of video displays 28 at the venue 24. Therefore, the audio/video may be outputted to Jumbotrons and visual displays 28 at the venue 24, the visual displays 28 being text, audio, video or combinations thereof. Because of the communication between the robotic module 22 and the visual displays 28, the system 20 allows bi-directional broadcasting in real-time. An end user 50 can send text or audio/video media to the robotic system 20, which can incorporate the transmitted media and broadcast it on visual displays 28 at the venue 24 in real-time. This broadcast can also be transmitted to remote viewers via the integrated broadcast system 10.

In other embodiments, input/output feeds may be transmitted to and received from the control center 30 or data center 35. Like above, the control center 30 can pull audio/video data from the robotic module 22 or push audio/video data to the robotic module 22 to be projected on Jumbotrons or other type of video displays 28 at the venue 24. The control center 30 can also pull audio/video data from the data center 35 or push audio/video data to the data center 35. Thus, the control center 30 can pull audio/video data from a first venue 24, whether via the robotic module 22 or video display 28, and project it on the video display 28 at a second venue 24, and vice versa. Likewise, the control center 30 can pull audio/video data from the data center 35 and project it on any video display 28 at any venue 24. The control center 30 can also broadcast the media content to remote viewers. The control center 30 can also cause the projection of the audio/video data, from either the robotic module 22 or the data center 35, to multiple video displays 28 across multiple venues 24 via multiple robotic modules 22. In other instances, advertising or promotional messages may be inserted into the programming and projected on the Jumbotrons or visual displays 28, the advertising or promotional message being provided by the local venue 24, robotic module 22, control center 30, data center 35 or a third party in communication with the robotic system 20. Alternatively, the advertising or promotional message may also be provided on the media content and viewed by the end user 50. Like above, because of the bidirectional capability and the ability to broadcasting in real-time, an end user 50 can send text or audio/video media for live broadcast on the visual displays 28 at the venue 24 or globally to remote viewers via the integrated broadcast system 10.

The robotic module 22 is capable of outputting feeds to the control center 30 and data center 35 via broadband communication including dish to satellite or point to point. The input/output signals may be transmitted between the robotic module 22, control center 30 and data center 35 using NTSC/PAL or high-definition (HD) standards incorporating suitable encoders, decoders and converters. The input/output signals may also be fed to storage disk recorders 27 and to local multi-media DVD burners 29 for distribution. In other words, the live event taking place at the venue 24 may be burned onto CDs, VCDs or DVDs using suitable hardware burners 29 for local distribution at the venue 24 immediately after the conclusion of the event. The input/output signals may also be stored on storage devices 27 including SD cards, flash cards and any other suitable storage devices for delayed playback. The CD or DVD burners 29 can pull the desired data from the storage devices 27 as needed. Initially, the robotic module 22 captures the broadcast and stores it on a database or server (not shown) within the robotic system 20. The robotic module 22 can also store the broadcast on hard drives or other suitable storage devices 27 within the robotic system 20. Once the broadcast has been stored, it can be retrieved from storage at the conclusion of the event. The data is subsequently sent to hardware burners 29 to provide instant digital recording of the event at the venue 24 in DVD or other suitable format and made available to the public via the Internet or other sales streams. It will be appreciated by those skilled in the art that storing, recording, digitizing and burning of broadcast events may involve controllers and other hardware devices and software programs not described herein.

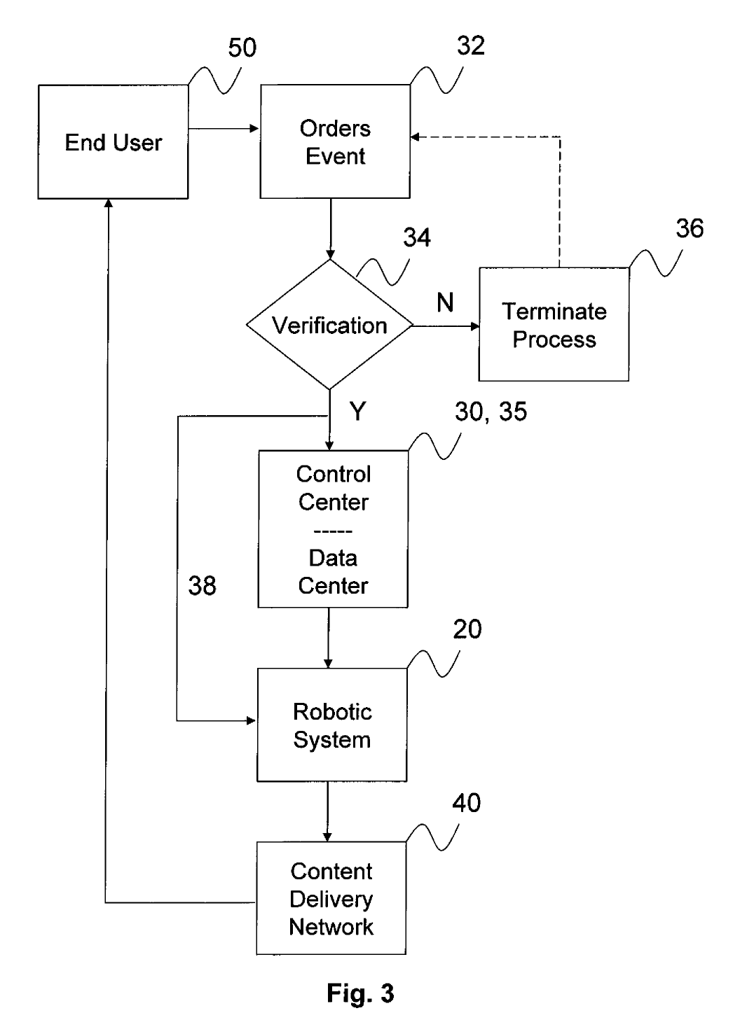

FIG. 3 is a block diagram illustrating a method of ordering a media content through the integrated broadcast system 10. An end user 50 initially decides whether to order an event 32 and if so which event including the likes of sporting events and concerts. As described above, the order can be placed through a plurality of wired or wireless devices. Once an order has been placed and verified 34, it is transmitted to the control center 30, data center 35 or robotic system 20. If the order cannot be verified, the process is terminated 36 and the user 50 is contacted to decide whether to place another order for the same event or a different event. When a verified order is at the control center 30 or data center 35, the control center 30 or data center 35 contacts the robotic system 20 related to the event and is readied to push/pull the necessary audio/video data. When a verified order is sent to the robotic system 20 directly 38 bypassing the control center 30 and data center 35, the event is ready to be provided to the end user 50 via the robotic system 20 directly. Once the event commences, the live event feed is provided to the end user 50 via the content delivery network 40. Alternatively, pre-recorded events may also be provided to the end user 50.

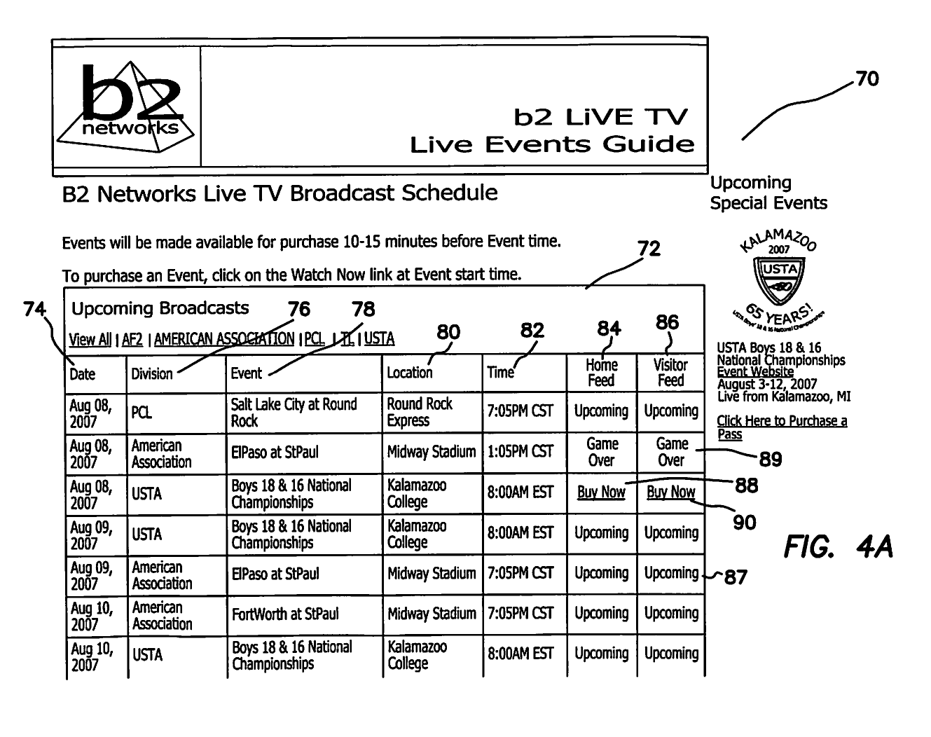

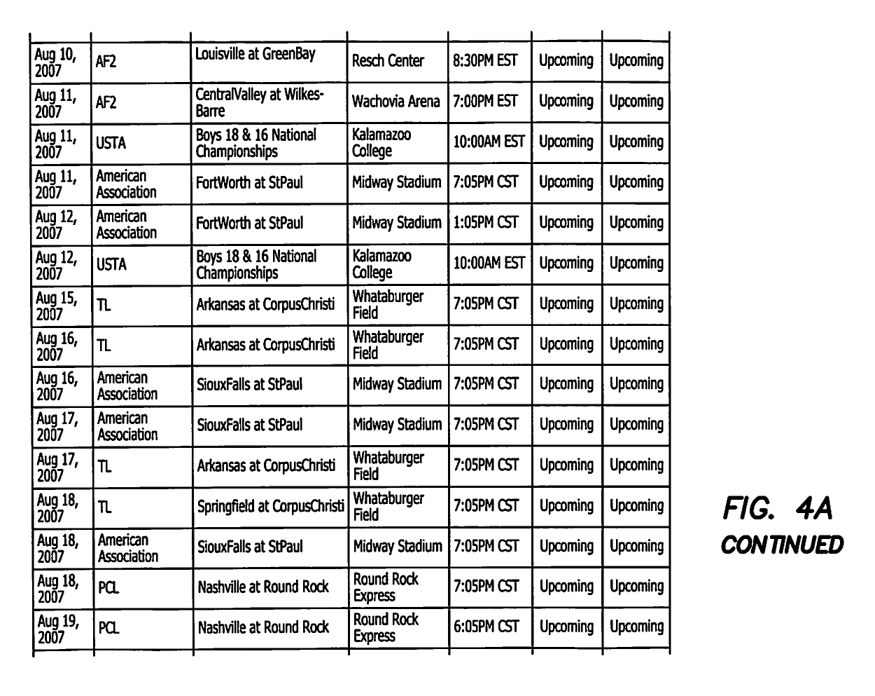

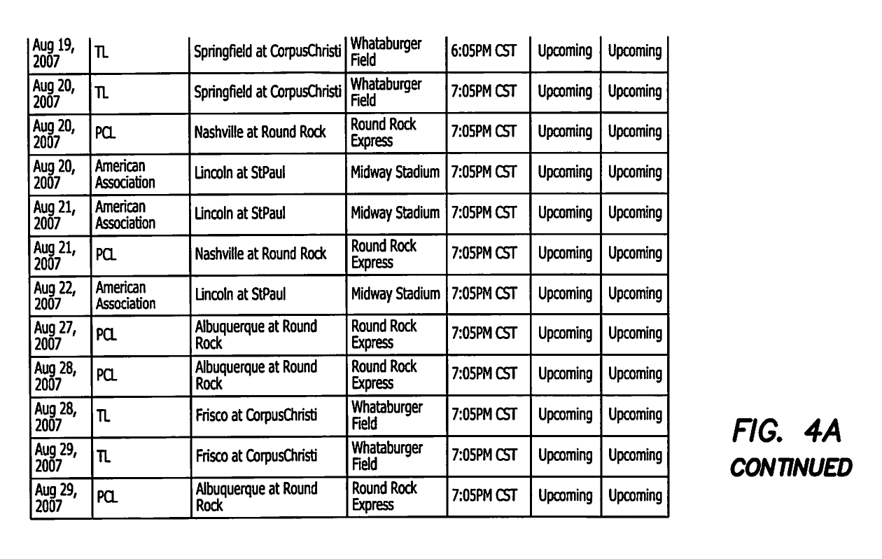

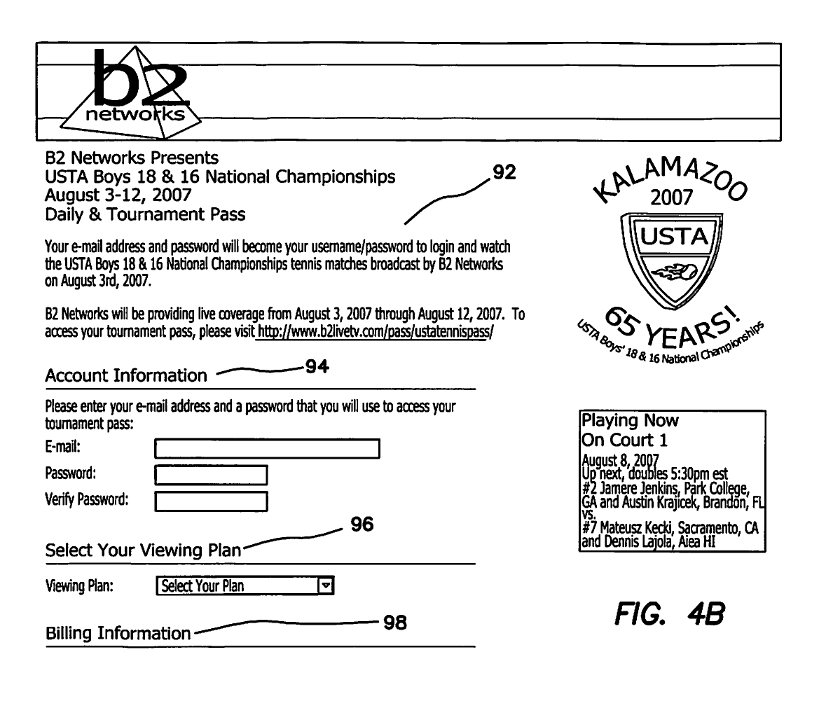

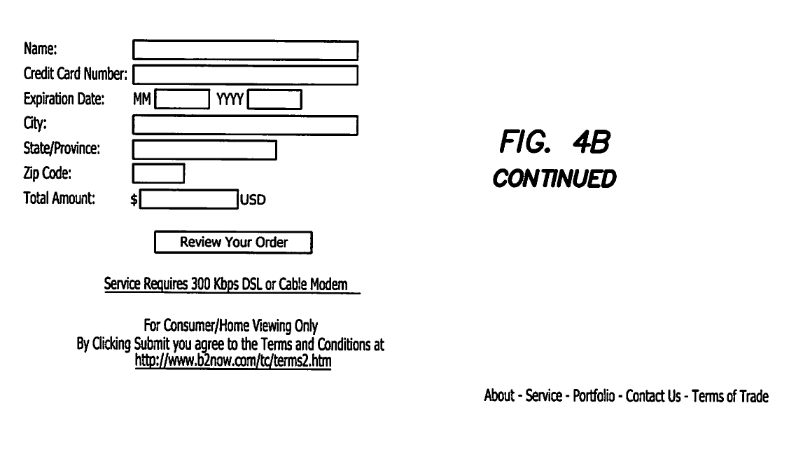

FIG. 4A shows an exemplary web page 70 listing a schedule 72 of upcoming live events. The schedule 72 includes a column for the date 74, division 76, event 78, location 80, time 82, home feed 84 and visitor feed 86. As set forth on the web page 70, in one embodiment, live events may be purchased 10-15 minutes prior to the event time. Therefore, many of the home feed 84 and visitor feed 86 columns indicate “Upcoming” 87, indicating that the event is not yet ready for purchase or “Game Over” 89 indicating that the game is over and therefore no live coverage is available (recorded footage may be available). In other instances, when the event is ready to be purchased, the home feed 84 and visitor feed 86 column include active “Buy Now” links 88, 90. Therefore, the customer 50 has the option to purchase the home team or visiting team feed. In most cases the customer 50 selects the feed of the team to which the customer 50 has pledged his or her loyalty. In response to clicking on one of the active Buy Now links 88, 90, the customer 50 is linked to a secure purchase web page 92 as shown in FIG. 4B. The customer is then able to enter requested information including account information 94, viewing plan 96 and billing information 98. Upon verification of the requested information, the customer is registered to receive the selected feed corresponding to the purchased live event.

In one embodiment of the present invention non-major collegiate sporting events (e.g., lacrosse) and hockey games involving non-NHL teams are broadcast. However, any live events can be broadcast using the embodiments of the present invention.

Although the invention has been described in detail with reference to several embodiments, additional variations and modifications exist within the scope and spirit of the invention as described and defined in the following claims.

What is claimed:

1. A robotic system for a venue comprising:
broadcast equipment disposed about the venue, said broadcast equipment operable to capture audio and video data relative to a live event;
at least one robotic module in communication with the broadcast equipment, the robotic module configured to receive said audio and video data from the broadcast equipment;
a control center wherein said control center is configured to pull audio and video data from the robotic module; and
means for transmitting said audio and video data to remote locations.

2. The system of claim 1, wherein the robotic module is configured to send audio and video contents to the broadcast equipment.

3. The system of claim 1, wherein said robotic module is configured to send audio and video data to one or more visual displays disposed about the venue.

4. The system of claim 3, wherein the robotic module is further configured to receive audio and video data from the one or more visual displays.

5. The system of claim 1, further comprising a plurality of data burners disposed about the venue, the burners configured to receive audio and video data from the robotic module.

6. The system of claim 1, wherein the broadcast equipment comprises at least microphones and cameras.

7. An integrated broadcast system comprising:
a plurality of robotic modules;
a control center in communication with the plurality of robotic modules, the control center configured to pull audio and video data from the plurality of robotic modules; and
means for transmitting said audio and video data to remote locations.

8. The system of claim 7, wherein the control center is configured to push audio and video contents to the plurality of robotic modules.

9. The system of claim 7, wherein each robotic module is associated with a unique venue.

10. The system of claim 9, wherein the control center is configured to pull first audio and video data from a first robotic module at a first venue and push the first audio and video data to a second robotic module at a second venue.

11. The system of claim 7, further comprising a plurality of data burners disposed about the venue, the burners configured to receive audio and video data from the associated robotic module.

12. The system of claim 7, wherein said robotic module is configured to send audio and video data to one or more visual displays disposed about the venue.

13. The system of claim 12, wherein the robotic module is further configured to receive audio and video data from the one or more visual displays.

14. The system of claim 13, wherein the broadcast equipment comprises at least microphones and cameras.

15. A method of providing audio and video content from a venue comprising:
utilizing broadcast equipment disposed about the venue to capture audio and video data relative to a live event;
configuring at least one robotic module in communication with the broadcast equipment to receive said audio and video data from the broadcast equipment;
configuring a control center to pull audio and video data from the robotic module; and
transmitting said audio and video data to remote locations.

16. The method of claim 15, further comprising configuring the robotic module to send audio and video data to the broadcast equipment.

17. The method of claim 15, further comprising configuring said robotic module to transmit audio and video data to a plurality of visual displays disposed about the venue.

18. The method of claim 17, further comprising configuring said robotic module to receive audio and video data from the plurality of visual displays.

19. The method of claim 15, further comprising configuring said robotic module to transmit audio and video data to a plurality of burners disposed about the venue.

20. A method of providing audio and video content across a broadcast network comprising:
disposing a plurality of robotic modules about the network;
configuring a control center in communication with said network to pull audio and video data from the plurality of robotic modules; and
transmitting said audio and video data to remote locations.

21. The method of claim 20, further comprising configuring the control center to push audio and video data to the plurality of robotic modules.

22. The method of claim 20, further comprising wherein each venue is associated with each robotic module disposed about the network.

23. The method of claim 20, further comprising configuring the control center to pull first audio and video data from a first robotic module at a first venue and push the first audio and video content to a second robotic module at a second venue.

24. The method of claim 20, further comprising disposing a plurality of burners about the venue, the burners configured to receive audio and video contents from the associated robotic module.

25. The method of claim 20, further comprising configuring the robotic modules to transmit audio and video data to a plurality of visual displays disposed about the venue.
